(19) United States
(12) Patent Application Publication
(10) Pub. No.: US 2018/0234567 A1
(43) Pub. Date: Aug. 16, 2018

(54) SCANNER HAVING A DOCUMENT SHREDDING MECHANISM

(71) Applicant: KYOCERA Document Solutions Inc., Osaka (JP)

(72) Inventor: Oleksandr Osadchyy, Concord, CA (US)

(73) Assignee: KYOCERA Document Solutions Inc., Osaka (JP)

(21) Appl. No.: 15/433,711

(22) Filed: Feb. 15, 2017

(51) Int. Cl. H04N 1/00; H04N 1/44; B02C 18/00; B02C 18/22

(52) U.S. Cl. CPC H04N 1/00657; H04N 1/4473; H04N 1/00588; H04N 2201/0094; H04N 1/00411; B02C 18/0007; B02C 18/2283; H04N 1/00591

(57) ABSTRACT

An image forming apparatus has a scanning apparatus. The scanning apparatus has a control panel to enter operating instructions to the image forming apparatus to scan and store a document or scan, store and shred the document. The scanning apparatus has a feeding mechanism. A scanning mechanism is coupled to the feeding mechanism scanning and storing the document placed within the feeding mechanism. A shredding apparatus is coupled to the scanning apparatus. The shredding apparatus has a housing. A shredding feed mechanism is coupled to the scanning apparatus feeding the document from the scanning apparatus into the shredding apparatus when scan, store and shred is selected on the control panel. A cutting mechanism is in communication with the shredding feed mechanism shredding the document when scan, store and shred is selected on the control panel.

### TECHNICAL FIELD

The present application in general relates to a printing/scanning device, and more specifically, to a multi-purpose device which may scan and store a document and shred the original document that was scanned.

### BACKGROUND

As technology progresses, more individuals and companies are moving away from paper documents/records and towards electronic documents. However, care must be taken when disposing of important and confidential paper documents to protect oneself, employees, as well as customers of the company. Carelessly discarded documents may be used by criminals for the purposes of identity theft. Additionally, privacy laws might require the safe disposal of certain types of documents, such as client files or health and insurance records.

Many individuals and companies may scan old paper documents in order to move towards electronic documents (i.e., e-documents). However, once the paper documents are scanned, many individuals do not know how to properly dispose of them. Even when a shredding unit may be located near the scanning unit, many individuals may not use the shredding unit due to the time needed to wait for the scan job to be processed through the scanning unit and then the time it may take to feed the scanned papers to the shredding unit. Thus, many individuals throw the old paper documents into a pile for disposing/shredding at a later time once the paper documents have been scanned. Alternatively, some may throw the old paper documents into a container and call for a disposal company to properly dispose of the old paper documents once these documents have been scanned.

Presently, there is not a device that may allow a user to scan a paper document, store the electronic copy of the scanned paper document on a permanent drive and pass the original paper document to a shredding unit so that the shredding unit may destroy the original paper document so that only the electronic copy remains. Currently, scanning and disposing of paper documents is a two step process. Individuals generally have to scan the paper document using a scanning device and then take the paper document to a shredding unit after the paper document has been scanned.

Therefore, it would be desirable to provide a system and method that overcomes the above.

### SUMMARY

In accordance with one embodiment, an image forming apparatus is disclosed. The image forming apparatus has a scanning apparatus. The scanning apparatus has a control panel to enter operating instructions to the image funning apparatus to scan and store a document or scan, store and shred the document. The scanning apparatus has a feeding mechanism. A scanning mechanism is coupled to the feeding mechanism scanning and storing the document placed within the feeding mechanism. A shredding apparatus is coupled to the scanning apparatus. The shredding apparatus has a housing. A shredding feed mechanism is coupled to the scanning apparatus feeding the document from the scanning apparatus into the shredding apparatus when scan, store and shred is selected on the control panel. A cutting mechanism is in communication with the shredding feed mechanism shredding the document when scan, store and shred is selected on the control panel.

In accordance with one embodiment, an image forming apparatus is disclosed. The image forming apparatus has a scanning apparatus. The scanning apparatus has a control panel to enter operating instructions to the image forming apparatus by a user. The control panel allows the user to scan and store a document or scan, store and shred the document. The scanning apparatus has a document feeding mechanism. A scanning mechanism is coupled to the document feeding mechanism. The scanning mechanism is used for scanning and storing the document placed within the feeding mechanism. A storage area is provided for holding the document after the document is scanned when scan and store is selected on the control panel. A shredding apparatus is coupled to the scanning apparatus. The shredding apparatus has a housing. A shredding feed mechanism is coupled to the scanning apparatus feeding the document into the shredding apparatus when scan, store and shred is selected on the control panel. A cutting mechanism is in communication with the shredding feed mechanism shredding the document when scan, store and shred is selected on the control panel. An external feed mechanism is coupled to the housing and in communication with the cutting mechanism sending extraneous documents directly to the shredding apparatus. A cover is hingely coupled to the housing allowing access to an interior of the shredding apparatus. A storage area is coupled to the housing and below the cutting mechanism storing the document that has been shredded.

In accordance with one embodiment, an image forming apparatus is disclosed. The image forming apparatus has a scanning apparatus. The scanning apparatus comprises: a control panel to enter operating instructions to the image forming apparatus by a user to scan and store a document or scan, store and shred the document; a document feeding mechanism; a scanning mechanism coupled to the document feeding mechanism, the scanning mechanism scanning and storing the document placed within the feeding mechanism; a print mechanism to print the document scanned by the scanning mechanism when a print command is entered in the control panel; and a storage area coupled to the second output port holding the document when scan and store is selected on the control panel. A shredding apparatus is coupled to the scanning apparatus. The shredding apparatus comprises: a housing; a shredding feed mechanism coupled to the scanning apparatus feeding the document from the scanning apparatus into the shredding apparatus when scan, store and shred is selected on the control panel; a cutting mechanism in communication with the shredding feed mechanism shredding the document when scan, store and shred is selected on the control panel, wherein the cutting mechanism comprises at least one shredding track comprising: a drive mechanism rotating the shredding track; a pair of guide wheels, wherein one of the pair of guide wheels is coupled to the drive mechanism; a belt coupled to and rotatable around the pair of guide wheels; a plurality of cutting platforms coupled to the belt, rotation of the belt causing the plurality of cutting platforms to move drawing the document through the cutting mechanism and shredding the document; and guide rails directing the plurality of cutting platforms along the belt. An external feed mechanism is coupled to the housing and in communication with the cutting mechanism sending extraneous documents directly to the shredding apparatus. A cover hingely is coupled to the housing allowing access to an interior of the shredding apparatus. A storage area is coupled to the housing and below the cutting mechanism storing the document that has been shredded.

### BRIEF DESCRIPTION OF THE DRAWINGS

The present application is further detailed with respect to the following drawings. These figures are not intended to limit the scope of the present invention but rather illustrate certain attributes thereof.

FIG. 1 is a diagram of an exemplary device for scanning, printing and shredding of documents according to one aspect of the present application;

FIG. 2 is a diagram showing a shredding mechanism having a single shredding track for the device depicted in FIG. 1 in accordance with one aspect of the present application;

FIG. 3A is a magnified view of the shredding track depicted in FIG. 2 according to one aspect of the present application;

FIG. 3B is a cross-sectional view of the shredding track depicted in FIG. 3A according to one aspect of the present application;

FIG. 4 is another magnified view of the shredding track depicted in FIG. 2 according to one aspect of the present application;

FIG. 5 is an exemplary embodiment of a cutting stair used in the shredding track depicted in FIG. 2 according to one aspect of the present application;

FIG. 6 is an exemplary embodiment of a drive assembly for moving the shredding mechanism depicted in FIG. 2 according to one aspect of the present application;

FIG. 7 is another embodiment of the shredding mechanism having a press cover for the device depicted in FIG. 2 according to one aspect of the present application;

FIG. 8 is another embodiment of the shredding mechanism having two shredding tracks for the device depicted in FIG. 2 according to one aspect of the present application;

FIG. 9 is an exemplary embodiment of a flowchart depicting a method for scanning and shredding a document according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method disclose a multi-function device that may scan a document and shred the document after the document has been scanned. The user may feed the document to a scanning mechanism of the multi-function device. The multi-function device scans the document and stores a scanned electronic copy of the document on a storage device. The multi-function device may pass the document that was scanned to a shredding pipeline. A shredding mechanism may destroy the document so that only the scanned electronic copy remains. The multi-function device may transfer the scanned electronic copy to a server and then delete the local scanned electronic file from the multi-function device. In case of failure to transfer the scanned electronic document to the server, the user may have an option to print a hard copy of the scanned document and the delete the scanned electronic copy from the multi-function device.

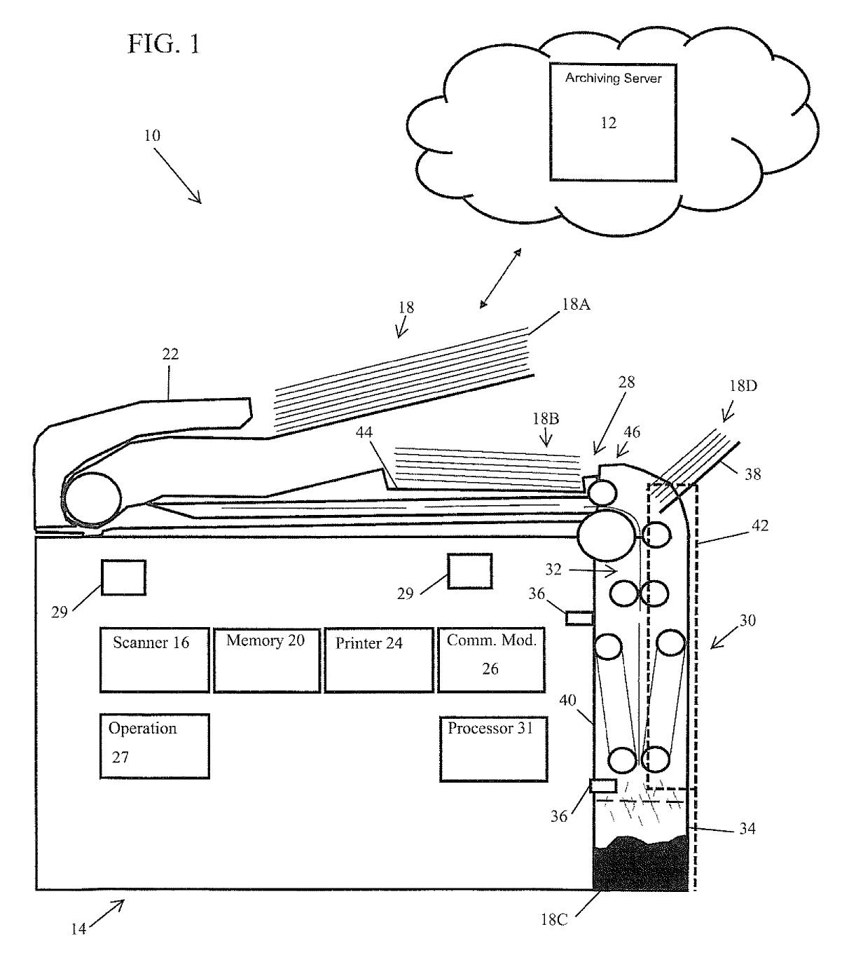

Referring now to FIG. 1, a system 10 may be shown. The system 10 may allow a document to be scanned so that a scanned electronic file is stored locally on a multi-function device 14. The document may then be shredded by the multi-function device 14. The scanned electronic file may be transferred to a storage server 12. If the scanned electronic file is not properly transferred to the storage server 12, the multi-function device 14 may print a hard copy of the scanned document. The multi-function device 14 may be connected to the storage server 12 directly or through a network. The network may be a local area network (LAN), a general wide area network (WAN), wireless local area network (WLAN) and/or a public network. The components of the system 10 may be coupled through wired or wireless connections.

The multi-function device 14 may be any type of device having multiple capabilities including a scanner and one or more of functions of a copier, a facsimile device, a printer and/or other types of rendering devices. The image forming device 14 may be used for scanning a document and shredding the document as described below.

The multi-function device 14 may have a scanning unit 16. The scanning unit 16 may be used to scan a document 18 and convert the document from a paper form into digital data file. The digital data file may be saved in a memory unit 20 of the multi-function device 14.

The multi-function device 14 may have a document feeding mechanism 22. The document feeding mechanism 22 may allow a user of the multi-function device 14 to place the document 18 into the document feeding mechanism 22 and have the document feeding mechanism 22 feed individual pages 18A of the document 18 into the multi-function device 14. This may allow a user of the system 10 to scan the document 18 without having to manually input each page 18A of the document 18.

The multi-function device 14 may have a printing unit 24. The printing unit 24 may be used in conjunction with the scanning unit 16 to allow the multi-function device 14 to function as a copier. In accordance with one embodiment, the printing unit 24 may be used to print a hard copy of the document 18 that was scanned into the multi-function device 14 as will be described below.

The multi-function device 14 may have one or more communication modules 26. The communication modules 26 may allow the multi-function device 14 to communicate and transfer the scanned electronic copy of the document to the storage server 12. The communication modules may allow for a direct transfer of the scanned electronic copy to the storage server 12 or via one or more networks such as a local area network (LAN), a general wide area network (WAN), wireless local area network (WLAN) and/or a public network.

The multi-function device 14 may have an operation panel 27. The operation panel 27 may include a display unit and an input unit for facilitating human interaction with the multi-function device 14. The display unit may be any electronic video display, such as a LCD display, LED display and similar display types. The input unit may include any combination of devices that allow users to input information into the operation panel 27, such as buttons, a keyboard, switches, and/or dials. In addition, the input unit may include a touch-screen digitizer overlaid onto the display unit that can sense touch and interact with the display unit. The operation panel 27 may be used to control the operation of the multi-function device 14. For example, the operation panel 27 may be used to scan the document 18, scan the document 18 and shred the scanned document 18B, scan the document 18 and store an electronic file of the scanned document 18B in a memory unit 20 and or server 12 prior to shredding the scanned document 18B, print a copy of the scanned document 18B, make a copy of the original document 18, and the like. The above listing is given as examples and should not be seen in a limiting manner.

The multi-function device may pass the document that was scanned to a shredding pipeline. A shredding mechanism may destroy the document so that only the scanned electronic copy remains. The multi-function device may transfer the scanned electronic copy to a server and then delete the local scanned electronic file from the multi-function device. In case of failure to transfer the scanned electronic document to the server, the user may have an option to print a hard copy of the scanned document and the delete the scanned electronic copy from the multi-function device.

The multi-function device 14 may have one or more sensors 29. Each sensor 29 may be used to monitor certain operating conditions of the multi-function device 14. Sensors 29 may be used to indicate a location of a paper jam, document miss-feed, toner level, as well as other operating conditions. The above is given as examples and should not be seen in a limiting manner. Each sensor 29 may be coupled to a processor 31. When a sensor 29 detects an operational issue, the sensor 29 may send a signal to the processor 31. The processor 31 may generate an error alert associated with the operational issue.

The multi-function device 14 may have a shredding feed unit 28. The shredding feed unit 28 may receive the document 18 once it has been scanned by the scanning unit 16. The shredding feed unit 28 may then feed the scanned document 18B to a shredding unit 30 coupled to the multi-function device 14. In accordance with one embodiment, shredding feed unit 28 may send the scanned document 18B once the entire document 18 has been scanned. The shredding feed unit 28 may be configured to send individual pages of the scanned document 18B, a set amount of pages of the scanned document 18B, the entire scanned document 18B or the like. Alternatively, once a page of the document 18 has been scanned, the shredding feed unit 28 may send the page of the scanned document 18A directly to the shredding unit 30. One or more sensors 29 may be used to monitor when the document 18 has been scanned and when the shredding feed unit 28 should feed the scanned document 18B to the shredding unit 30.

As may be seen in FIG. 1, the shredding unit 30 may have a housing 40. The housing 40 may be in communication with the shredding feed unit 28. A shredding mechanism 32 may be located within the housing 40. The shredding mechanism 32 may be used for shredding the scanned document 18B sent to the shredding unit 30. The shredding mechanism 32 may be designed to shred the scanned document 18B using a cross-cut or micro-cut cutting configuration. The shredding mechanism 32 may further be designed to cut non-paper items such as plastic (compact discs (CDs) or small metal items like staples, paper clips and the like.

Once the shredding mechanism 32 has shredded the scanned document 18B, the shredded document 18C may be disposed in a collection unit 34 coupled to a bottom section of the shredding unit 30.

The shredding unit 30 may have one or more sensors 36. The sensors 36 may be used to indicate different operating conditions of the shredding unit 30. For example, sensors 36 may be used to indicate if the shredding unit 30 is activated, speed of the document 18 being scanned, if there is a paper jam within the shredding mechanism 32, when the collection unit 34 is full, as well as other operating conditions. The above is given as examples and should not be seen in a limiting manner. The sensors 36 may allow shredding unit 30 to adjust to different operating conditions. For example, sensors 36 may be provided to monitor the scanning speed of the scanning unit 16. Based on the scanning speed, the speed of the shredding unit 30 may be automatically adjusted. Thus, the multi-function device 14 may automatically adjust to different scanning speeds of the multi-function device 14 thereby allowing application on a range of high and low speed models, as well as scanning modes. This allows optimizing the energy consumption by the shredding unit 30. However, by design, the shredding speed does not have to match the scanning speed. The scanning unit 16 may operate at two or more times the shredding speed. This embodiment may lessen cost as for certain sensors 36 and controls may not be necessary. The above is given as an example and should not be seen in a limiting manner.

The shredding unit 30 may have an exterior feed tray 38 coupled to the housing 40 and in communication with the shredding mechanism 32. The exterior feed tray 38 may be used to feed an external document 18D directly to the shredding unit 30. The exterior feed tray 38 may allow a user to bypass having to scan the external document 18D prior to shredding it. The external document 18D may be any document that does not need to be scanned but the user wishes to dispose of such as recyclable papers, crumbled papers, bulk papers, as well as non paper items such as compact discs (CDs), credit cards, and the like.

The shredding unit 30 may have a cover 42 coupled to the housing 40. The cover 42 may be hinged to the housing 40. The cover 42 may allow access to the interior of the shredding unit 30. This may allow users to unblock paper jams and/or service the shredding unit 30.

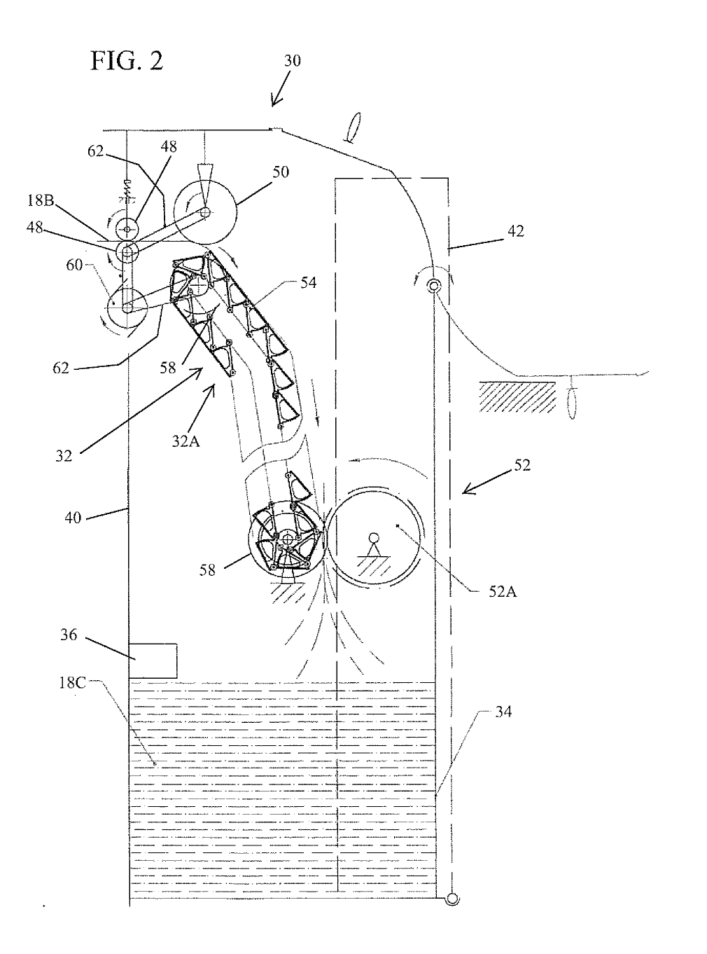

Referring to FIGS. 1-2, the shredding feed unit 28 may have a storage area 44 for holding the scanned document 18B. A feeding unit 46 may be used to move the scanned document 18C form the storage area 44 to the shredding mechanism 32. As stated above, the feeding unit 46 may be designed to send individual pages of the scanned document 18B, a set amount of pages of the scanned document 18B, the entire scanned document 18B or the like. Alternatively, once a page of the document 18 has been scanned, the shredding feed unit 28 may send the page of the scanned document 18B directly to the shredding unit 30.

In accordance with one embodiment, the feeding unit 46 may be used to move the scanned document 18C form the storage area 44 to the shredding unit 30 and into the shredding mechanism 32. The feeding unit 46 may be comprised of a pair of feed rollers 48. The feed rollers 48 may be coupled to the housing 40. The feed rollers 48 may be in communication with the storage area 44 such that the feed rollers 48 engage and pull the scanned document 18B into the housing 40. A guiding device 50 may be coupled to the housing 40. The guiding device 50 may be used to direct the scanned document 18B fed from the feed rollers 48 into the shredding mechanism 32. In accordance with the embodiment shown in FIG. 2, the guiding device 50 may be a guide roller 50A. As the guide roller 50A rotates, the rotation of the guide roller 50A may force the scanned document 18B down towards the shredding mechanism 32.

As the scanned document 18B is fed into the shredding mechanism 32, a pressing device 52 may be used to press the scanned document 18B against the shredding mechanism 32. By pressing the scanned document 18B against the shredding mechanism 32, the shredding mechanism 32 may be able to shred the scanned document 18B. In the embodiment shown in FIG. 2, the pressing device 52 is a roller press 52A. The roller press 52A rotates which presses and moves the scanned document 18B through the shredding mechanism 32.

In the embodiment shown in FIGS. 2-5, the shredding mechanism 32 may be a shredding track 32A. The shredding track 32A may be formed of a plurality of cutting blocks 54. The cutting blocks 54 may be coupled together such that individual cutting blocks 54 are adjacent to one another. The cutting blocks 54 may be mounted to a rotating a belt 56. In accordance with one embodiment, the belt 56 may be a chain 56A. The belt 56 may be mounted on a pair of belt rollers 58. Rotation of the belt rollers 58 may cause rotation of the shredding track 32A. As the shredding track 32A moves, this may cause the scanned document 18B to be moved down the shredding track 32A and towards the roller press 52A. As the scanned documents 18B is pressed between the shredding tack 32A and the roller press 52A, the cutting blocks 54 may cut/shred the scanned document 18B.

The shredding unit 30 may have a motor 60. The motor 60 may be used for rotating either directly or indirectly at least one feed roller 48, the guide roller 50A, the roller press 52A, and one or more belt rollers 58. One or more drive belts 62 may be coupled to the motor 60 and to the feed rollers 48, the guide roller 50A, the roller press 52A, and one or more belt rollers 58. The drive belts 62 may be used to rotate the feed rollers 48, the guide roller 50A, the roller press 52A, and one or more belt rollers 58. As may be seen in the embodiment shown in FIG. 2, some drive belts 62 may be directly connected between the motor 60 and a roller, for example a feed roller 48. While other drive belts 62 may be coupled between rollers, for example between the feed roller 48 being driven by the motor 60 and the guide roller 50A.

Referring to FIGS. 2-5, the shredding track 32A may be disclosed in further detail. The shredding track 32A has a plurality of cutting blocks 54. The cutting block 54 may be arranged such that each cutting block 54 is adjacent to one another forming a staircase configuration. The cutting blocks 54 may be arranged such that a back end of a cutting block 54 may be coupled to a front end of a directly succeeding cutting block 54.

The cutting block 54 may be formed in different configurations. In the present embodiment the cutting block 54 may be quadrilateral in shape. The cutting block 54 may be configured such that a front end 54F is elevated above the back end 54B. However, as previously stated, the cutting block 54 may come in other configurations. A top surface 54T of the cutting block 54 may be planer in nature. In the present embodiment, the top surface 54T may be planer and may slope down towards the back end 54B.

The top surface 54T may have a plurality of cutting teeth 64. The cutting teeth 64 may extend up from and sloped down towards the top surface 54T of the cutting block 54. A plurality of perforated openings 66 may be formed through the top surface 54T. Thus, the top surface 54T may be configured similar to a grater wherein the openings 66 may allow portions of the scanned document 18B being shredded by the cutting teeth 64 to flow through the top surface 54T.

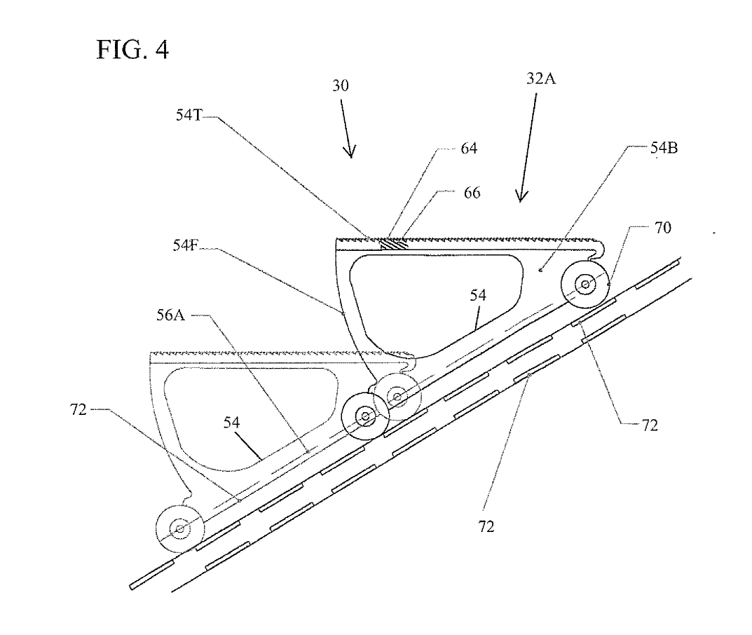

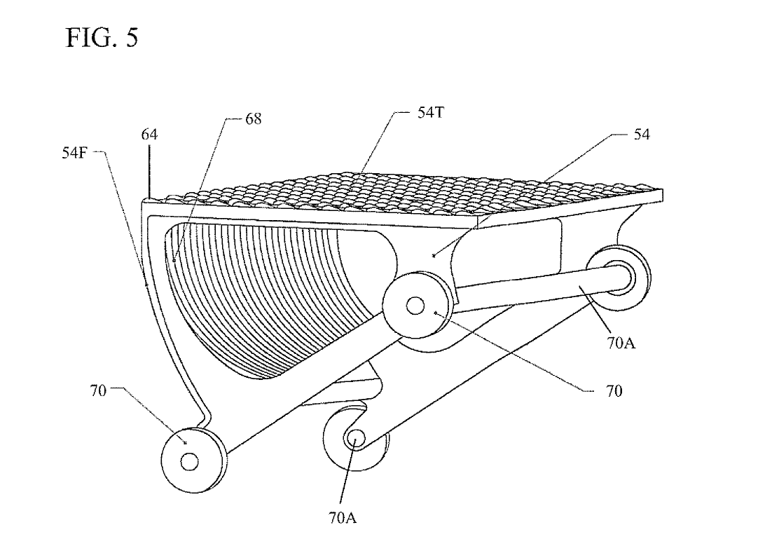

A front panel 54F of the cutting block 54 may have a plurality of cutting blades 68 formed thereon. In the present embodiment, the cutting blades 68 may extend from the top surface 54T towards a bottom area of the cutting block 54. The cutting blades 68 may have a bend/curve as shown in FIGS. 4-5. The cutting blades 68 may work in conjunction with the cutting teeth 64 to shred the scanned document 18B.

A plurality of rolling devices 70 may be coupled to the cutting block 54. The rolling devices 70 may be wheels, rollers, or similar devices. In accordance with one embodiment, a rolling device 70 may be rotatably coupled to each of four corners on a bottom area of the cutting block 54. The rolling devices 70 may be rotatably coupled to the cutting block 54 through an axle assembly 70A or by other rotating means.

As stated above, the cutting blocks 54 may be mounted to the rotating a belt 56. In accordance with one embodiment, the belt 56 may be a chain 56A. The cutting blocks 54 may be mounted such that one or more of the rolling devices 70 may be attached to the rotating chain 56A. In accordance with one embodiment, the shredding unit 30 may have a pair of chains 56A. Each rolling device 70 mounted on the bottom area of the back end 54B of the cutting block 54 may be attached to a separate chain 56A of the pair of chains 56A.

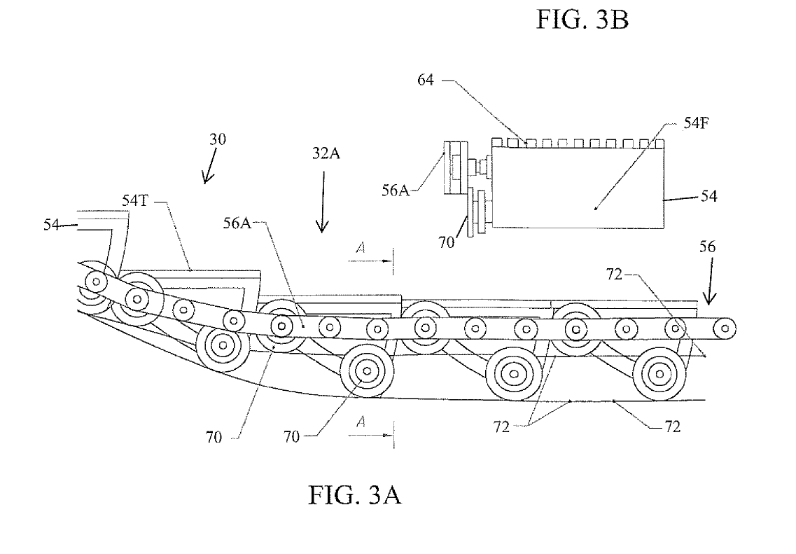

The cutting blocks 54 may ride within guide rails 72. The guide rails 72 may be used to direction and movement of the shredding track 32A. The guide rails 72 may be configured such that as the cutting blocks 54 rotate around, the top surface 54T of adjoining cutting blocks 54 may remain approximately level as shown in FIGS. 2-3. As the cutting blocks 54 moves towards the pressing device 52, the guide rails 72 may cause the cutting blocks 54 to move such that the top surface 54T of adjoining cutting blocks 54 become staggered forming a staircase configuration as shown in FIGS. 2 and 4.

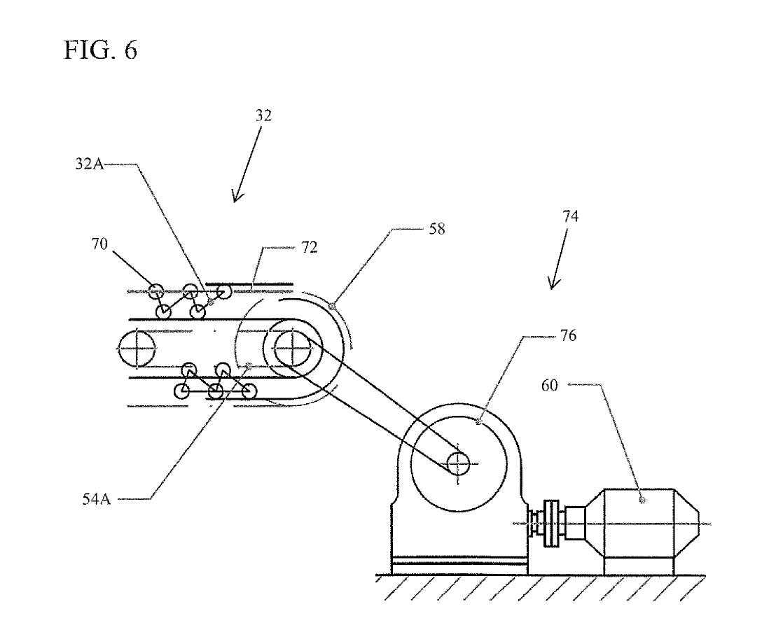

Referring to FIG. 6, a drive assembly 74 for rotating the shredding mechanism 32. The drive assembly 74 may be formed of the motor 60. The motor 60 may be coupled to gear mechanism 76. The gear mechanism 76 may allow one to control the speed and/or direction of rotation of the shredding mechanism 32. The gear mechanism 76 may rotate one or more belt rollers 58 thereby rotating the shredding mechanism 32 (i.e., the shredding track 32A) coupled thereto.

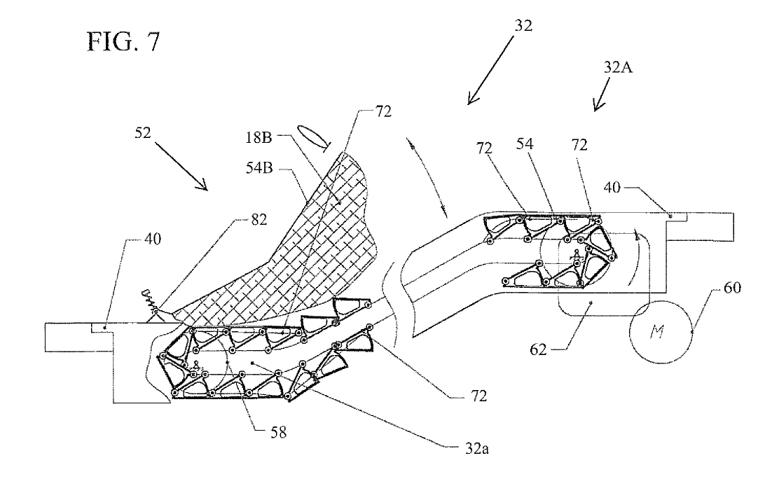

Referring to FIG. 7, another embodiment of the shredding mechanism 32 may be seen. In this embodiment, the shredding mechanism 32 may be mounted to the housing 40 via a base unit 80. The base unit 80 may be coupled to upper and lower sections of the shredding mechanism 32. As in previous embodiments, the shredding mechanism 32 may have a shredding unit 30 (FIG. 1). Like the previous embodiment, the shredding mechanism 32 may be shredding track 32A. The shredding track 32A may be formed of a plurality of cutting blocks 54. The cutting blocks 54 may be coupled together such that individual cutting blocks 54 are adjacent to one another. The cutting blocks 54 may be mounted to a rotating a belt 56. In accordance with one embodiment, the belt 56 may be a chain. Rotation of the belt rollers 58 may cause rotation of the shredding track 32A. As the shredding track 32A moves, this may cause the scanned document 18B to be moved down the shredding track 32A and towards the pressing device 52. As the scanned document 18B is pressed between the shredding track 32A and the pressing device 52, the cutting blocks 54 may cut/shred the scanned document 18B.

The shredding unit 30 may have a motor 60. The motor 60 may be used for rotating one or more belt rollers 58. One or more drive belts 62 may be coupled to the motor 60 and to one or more belt rollers 58. The drive belts 62 may be used to rotate the one or more belt rollers 58.

In the present embodiment, the pressing device 52 may be a press cover 52B. The press cover 52B may be configured to funnel the scanned document 18B towards a bottom section of the shredding track 32A where the scanned document 18B is pressed against the shredding track 32A. By pressing the scanned document 18B against the shredding track 32A, the shredding track 32A may be able to shred the scanned document 18B.

The press cover 52B may be coupled to a bottom section of the base unit 80. The press cover 52B may extend up and away from the base unit 80 thereby forming a funnel to direct the scanned document 18B towards a bottom section of the shredding track 32A.

A tensioning device 82 may be coupled to the press cover 52B and the base unit 80. The tensioning device 82 may be used to adjust an amount of pressure the press cover 52B may apply between the scanned document 18B towards a bottom section of the shredding track 32A. The tension device 82 may be coupled to one or more of the sensors 36 (FIG. 1). The sensors 36 may be used to monitor the thickness/thickness/number of pages in the scanned document 18B being directed to the bottom of the bottom section of the shredding track 32A and to send a signal to the tensioning device 82 to adjust the tensions accordingly.

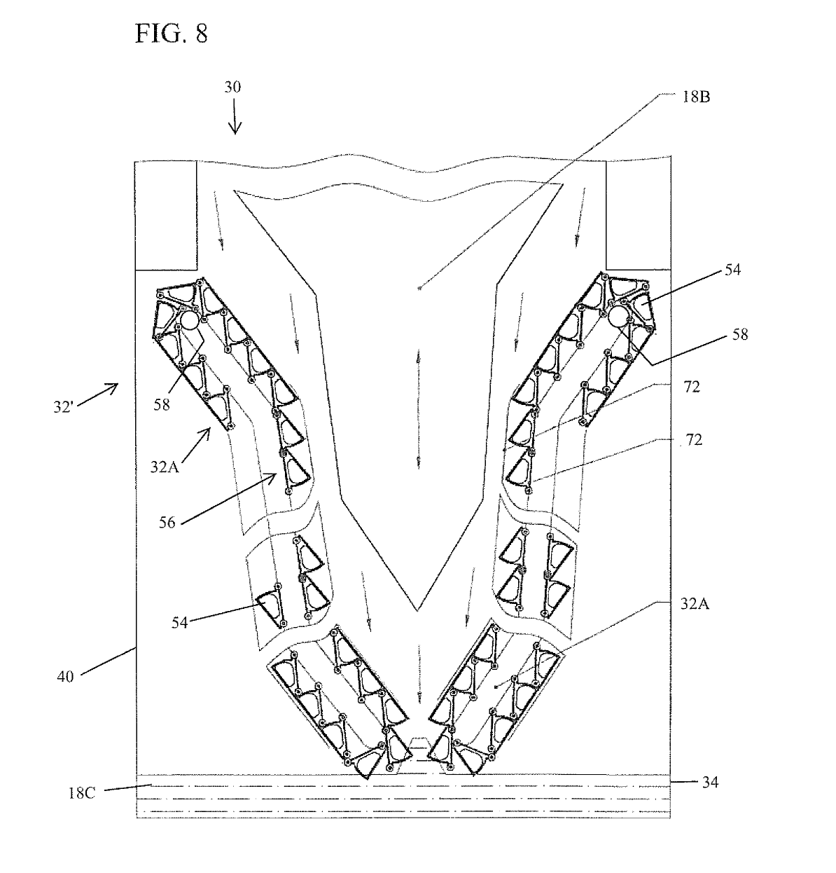

Referring to FIG. 8, another embodiment of the shredding mechanism 32′ is shown. In this embodiment, the shredding mechanism 32′ may be comprised of a pair of a shredding track 32A. The pair of shredding tracks 32A may be configured in a “V” formation. This may allow the scanned document 18B to be positioned within a top section of the “V” formation and funneled down towards a bottom of the “V” formation. A bottom section of the “V” formation may apply sufficient pressure to shred the scanned document 18B and pass the shredded document 18B out of the bottom section of the “V” formation.

Both of the shredding tracks 32A may be formed of a plurality of cutting blocks 54. The cutting blocks 54 may be coupled together such that individual cutting blocks 54 are adjacent to one another. The cutting blocks 54 may be mounted to a rotating a belt 56. In accordance with one embodiment, the belt 56 may be a chain. The belt 56 may be mounted on a pair of belt rollers 58. Rotation of the belt rollers 58 causes the scanned document 18B to be pressed between the pair of shredding track 32A allowing the cutting blocks 54 to shred the scanned document 18B. A motor may be used for rotating one or more belt rollers 58. One or more drive belts may be coupled to the motor and to one or more belt rollers 58. The drive belts may be used to rotate the one or more belt rollers 58.

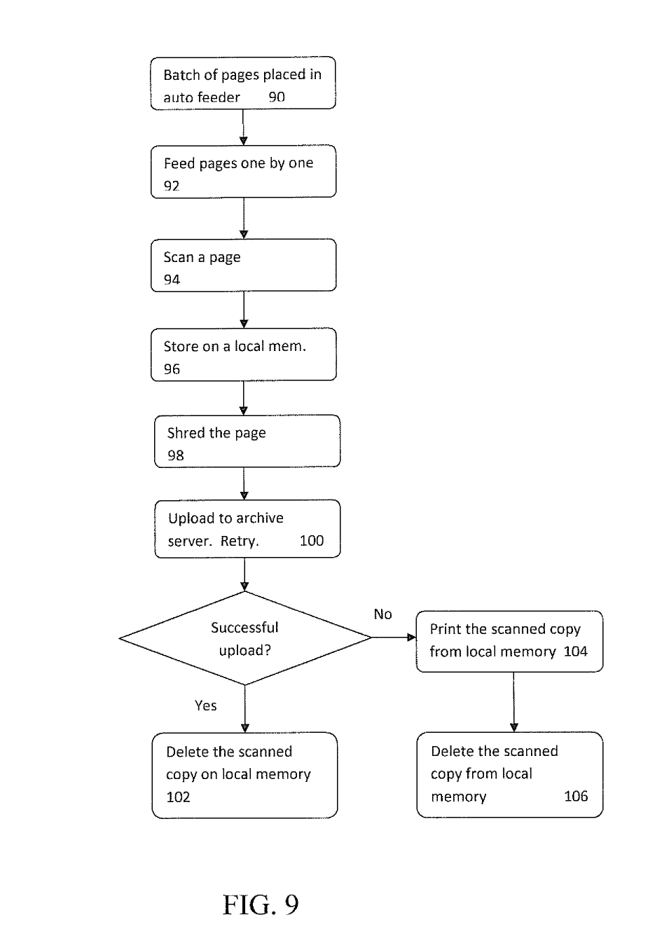

Referring now to FIGS. 1-9, operation of the system 10 may be disclosed. In operation, the document 18 may be positioned in the document feeding mechanism 22 of the multi-function device 14 as shown in 90. The document feeding mechanism 22 may feed individual pages 18A of the document 18 into the multi-function device 14 as shown in 92. A scanning unit 160f the multi-function device 14 may scan each page of the document 18 as shown in 94. The scanning unit 16 may convert the document 18 into digital data file and save the digital data file in a memory unit 20 of the multi-function device 14 as shown in 96. The multi-function device 14 may pass the document 18 that was scanned to the shredding mechanism 32 as shown in 98. The shredding mechanism 32 may destroy the document 18 so that only the scanned electronic copy remains. The multi-function device may try and transfer the scanned electronic copy to the storage server 12 as shown in 100. If the transfer to the storage server 12 is successful, the digital data file in the memory unit 20 of the multi-function device 14 may be deleted as shown in 102. In case of failure to transfer the scanned electronic document to the storage server 12, the user may have an option to print a hard copy of the scanned document as shown in 104 and then delete the digital data file in the memory unit 20 of the multi-function device 14 as shown in 106.

The foregoing description is illustrative of particular embodiments of the invention, but is not meant to be a limitation upon the practice thereof. The following claims, including all equivalents thereof, are intended to define the scope of the invention.

What is claimed is:

1. An image forming apparatus comprising:
a scanning apparatus comprising:
control panel to enter operating instructions to the image forming apparatus to scan and store a document or scan, store and shred the document;
a feeding mechanism; and
a scanning mechanism coupled to the feeding mechanism scanning and storing the document placed within the feeding mechanism;
a shredding apparatus coupled to the scanning apparatus, the shredding apparatus comprising:
a housing;
a shredding feed mechanism coupled to the scanning apparatus feeding the document from the scanning apparatus into the shredding apparatus when scan, store and shred is selected on the control panel; and
a cutting mechanism in communication with the shredding feed mechanism shredding the document when scan, store and shred is selected on the control panel.

2. The image forming apparatus of claim 1, wherein scanning apparatus comprises:
a storage area holding the document after the document is scanned when scan and store is selected on the control panel.

3. The image forming apparatus of claim 1, wherein the shredding apparatus comprises an external feed mechanism coupled to the housing and in communication with the cutting mechanism sending extraneous documents directly to the shredding apparatus.

4. The image forming apparatus of claim 1, wherein the shredding apparatus comprises a shredding storage area coupled to the housing and positioned below the cutting mechanism storing the document that has been shredded.

5. The image forming apparatus of claim 1, wherein the shredding apparatus comprises a plurality of sensors positioned within the housing monitoring operating conditions of the shredding apparatus.

6. The image forming apparatus of claim 1, wherein the shredding apparatus comprises a cover hingely coupled to the housing.

7. The image forming apparatus of claim 1, wherein the cutting mechanism comprises a single shredding track, the single shredding track comprising:
a drive mechanism rotating the single shredding track;
a pair of guide wheels, wherein one of the pair of guide wheels is coupled to the drive mechanism;
a belt coupled to and rotatable around the pair of guide wheels; and
a plurality of cutting platforms coupled to the belt, rotation of the belt causing the plurality of cutting platforms to move drawing the document through the cutting mechanism and shredding the document.

8. The image forming apparatus of claim 7, wherein the cutting mechanism comprises guide rails directing the plurality of cutting platforms along the belt.

9. The image forming apparatus of claim 7, wherein the cutting mechanism comprises a pressing mechanism forcing the document against the cutting platforms.

10. The image forming apparatus of claim 7, wherein each of the cutting platforms comprises:
an angled frame;
a perforated platform formed on a top surface of the frame;
a plurality of angled cutting teeth extending up from the perforated platform;
a plurality of cutting blades extending down from the perforated platform and forming a side cutting panel; and
a plurality of wheels coupled to a bottom area of the angled frame and to the belt.

11. The image forming apparatus of claim 1, wherein the cutting mechanism comprises multiple shredding tracks, wherein the scanning apparatus feeds the document between the multiple shredding tracks.

12. The image forming apparatus of claim 11, wherein each shredding track of the multiple shredding tracks comprises:
a drive mechanism rotating each shredding track;
a pair of guide wheels, wherein one of the pair of guide wheels is coupled to the drive mechanism;
a belt coupled to and rotatable around the pair of guide wheels;
a plurality of cutting platforms coupled to the belt, rotation of the belt causing the plurality of cutting platforms to move drawing the document through the cutting mechanism and shredding the document; and
a guide rail to directing the plurality of cutting platforms along the belt.

13. The image forming apparatus of claim 12, wherein each of the cutting platforms comprises:
an angled frame;
a perforated platform formed on a top surface of the frame;
a plurality of angled cutting teeth extending up from the perforated platform;
a plurality of cutting blades extending down from the perforated platform and forming a side cutting panel; and
a plurality of wheels coupled to a bottom area of the angled frame and to the belt.

14. The image forming apparatus of claim 1, wherein the scanning apparatus comprises a print mechanism to print the document scanned by the scanning mechanism.

15. The image forming apparatus of claim 1, wherein the scanning apparatus comprises a communication port to transfer an electronic file of the document scanned to an external storage device.

16. The image forming apparatus of claim 1, wherein a speed of the shredding apparatus automatically adjust to a scanning speed of the scanning apparatus.

17. An image forming apparatus comprising:
a scanning apparatus comprising:
control panel to enter operating instructions to the image forming apparatus by a user to scan and store a document or scan, store and shred the document;
a document feeding mechanism;
a scanning mechanism coupled to the document feeding mechanism, the scanning mechanism scanning and storing the document placed within the feeding mechanism; and
a storage area holding the document after the document is scanned when scan and store is selected on the control panel;
a shredding apparatus coupled to the scanning apparatus, the shredding apparatus comprising:
a housing;
a shredding feed mechanism coupled to the scanning apparatus feeding the document into the shredding apparatus when scan, store and shred is selected on the control panel;
a cutting mechanism in communication with the shredding feed mechanism shredding the document when scan, store and shred is selected on the control panel;
an external feed mechanism coupled to the housing and in communication with the cutting mechanism sending extraneous documents directly to the shredding apparatus;
a cover hingely coupled to the housing allowing access to an interior of the shredding apparatus; and
a storage area coupled to the housing and below the cutting mechanism storing the document that has been shredded.

18. The image forming apparatus of claim 17, wherein the cutting mechanism comprises a single shredding track, the single shredding track comprising:
a drive mechanism rotating the single shredding track;
a pair of guide wheels, wherein one of the pair of guide wheels is coupled to the drive mechanism;
a belt coupled to and rotatable around the pair of guide wheels;
a plurality of cutting platforms coupled to the belt, rotation of the belt causing the plurality of cutting platforms to move drawing the document through the cutting mechanism and shredding the document;
guide rails directing the plurality of cutting platforms along the belt; and
a pressing mechanism forcing the document against the cutting platforms.

19. The image forming apparatus of claim 17, wherein the cutting mechanism comprises multiple shredding tracks, wherein the scanning apparatus feeds the document between the multiple shredding tracks, wherein each shredding track of the multiple shredding tracks comprises:
a drive mechanism rotating each shredding track;
a pair of guide wheels, wherein one of the pair of guide wheels is coupled to the drive mechanism;
a belt coupled to and rotatable around the pair of guide wheels;
a plurality of cutting platforms coupled to the belt, rotation of the belt causing the plurality of cutting platforms to move drawing the document through the cutting mechanism and shredding the document; and
a guide rail to directing the plurality of cutting platforms along the belt.

20. An image forming apparatus comprising:
a scanning apparatus comprising:
control panel to enter operating instructions to the image forming apparatus by a user to scan and store a document or scan, store and shred the document;
a document feeding mechanism;
a scanning mechanism coupled to the document feeding mechanism, the scanning mechanism scanning and storing the document placed within the feeding mechanism;
a print mechanism to print the document scanned by the scanning mechanism when a print command is entered in the control panel; and
a storage area coupled to the second output port holding the document when scan and store is selected on the control panel;
a shredding apparatus coupled to the scanning apparatus, the shredding apparatus comprising:
a housing;
a shredding feed mechanism coupled to the scanning apparatus feeding the document from the scanning apparatus into the shredding apparatus when scan, store and shred is selected on the control panel;
a cutting mechanism in communication with the shredding feed mechanism shredding the document when scan, store and shred is selected on the control panel, wherein the cutting mechanism comprises at least one shredding track comprising:
a drive mechanism rotating the shredding track;
a pair of guide wheels, wherein one of the pair of guide wheels is coupled to the drive mechanism;
a belt coupled to and rotatable around the pair of guide wheels;
a plurality of cutting platforms coupled to the belt, rotation of the belt causing the plurality of cutting platforms to move drawing the document through the cutting mechanism and shredding the document; and
guide rails directing the plurality of cutting platforms along the belt;
an external feed mechanism coupled to the housing and in communication with the cutting mechanism sending extraneous documents directly to the shredding apparatus;
a cover hingely coupled to the housing allowing access to an interior of the shredding apparatus; and
a storage area coupled to the housing and below the cutting mechanism storing the document that has been shredded.
